(19) United States
(12) Patent Application Publication
(10) Pub. No.: US 2009/0279076 A1
(43) Pub. Date: Nov. 12, 2009

(54) SELF CALIBRATED MEASUREMENT OF INDEX OF REFRACTION CHANGES TO ULTRA-FAST PHENOMENA

(75) Inventors: Aaron C. Bernstein, Austin, TX (US); Todd Ditmire, Austin, TX (US); John R. Houser, Austin, TX (US)

Correspondence Address: WINSTEAD PC, P.O. BOX 50784, DALLAS, TX, 75201, US

(73) Assignee: Board of Regents, The University of Texas System, Austin, TX (US)

(21) Appl. No.: 12/463,245

(22) Filed: May 8, 2009

Related U.S. Application Data
(60) Provisional application No. 61/052,105, filed on May 9, 2008.

(51) Int. Cl. G01N 21/41

(52) U.S. Cl. 356/136

(57) ABSTRACT

A method for calibrating the angle-axis of signals measuring changes in an index of refraction. A pump beam is generated to propagate near a prism to induce index-changes in air by lining up air molecules outside of the prism. A generated probe beam is directed at the prism. A sinc² pattern is then generated in a far-field based on a diffraction of a laser beam from a slit, where the laser beam is directed at the prism. An angle-axis of the sinc² pattern is calibrated using maxima of the sinc² pattern.

### CROSS-REFERENCE TO RELATED APPLICATIONS

This application is related to the following commonly owned co-pending U.S. patent application:

Provisional Application Ser. No. 61/052,105, “Self Calibrated Measurement of Index of Refraction Changes to Ultra-Fast Phenomena,” filed May 9, 2008, and claims the benefit of its earlier filing date under 35 U.S.C. § 119(e).

### TECHNICAL FIELD

The present invention relates to the field of measuring index of refraction changes, and more particularly to using a self-calibration technique to measure the index of refraction changes to ultra-fast phenomena (e.g., gas) on a femtosecond time scale.

### BACKGROUND INFORMATION

The index of refraction of a material depends on its microscopic properties including its density, conductivity, and its molecular and electronic structure. In a world poised to be affected by nanotechnology, medicines based on new research on protein-folding, and the advent of molecular-based computers, the knowledge of how an index of refraction changes with time can yield great insight to many physical processes and how they may be applied. One way of detecting index of refraction changes is by measuring an optical probe beam after it undergoes total internal reflection. Total internal reflection (TIR) takes place, for example, when light traveling in glass encounters a glass-air interface, and the angle of approach (angle of incidence) is greater than a particular angle known as the critical angle for total internal reflection. As the name implies, TIR, in this case, is when all of the light energy is reflected at the interface back into the glass, and does not radiate into the air.

An optical instrument, commonly referred to as a “refractometer,” is used to determine the refractive index of a substance. Refractometers can be used for measuring gases, liquids, such as oils or water-based, and even transparent or translucent solids, such as gemstones. A refractometer may use the total internal reflection of a ray of light striking a glass-to-air boundary at a continuous range of angles with respect to the normal of the surface, including the critical angle, to determine the refractive index of a substance. Because the critical angle is sensitive to the ratio of refractive indices of both the glass and the air on the other side of the interface, its measurement is itself a sensitive measure of the index of refraction changes in either the air or the glass. An interesting facet to total internal reflection is that the light does not actually radiate into the outside medium. It is actually probing the index of refraction of a medium it does not transmit through and is therefore a “local” measurement.

As mentioned above, TIR takes place at angles of incidence greater than the critical angle, with a reflectivity of 1, representing that all the light (100%) is reflected. However, for incident angles just below the critical angle, the reflectivity changes very quickly, so it is a sensitive measure of that angle of incidence. The phase of the light that is totally reflected has a phase variation that changes very rapidly as a function of angle for incidence angles just above critical angle.

Historically, accurate measurements of the critical angle (and hence the ratio of indices of refraction) rely on highly controlled incident probe beams, usually involving spatial filtering and collimation. This involves a high level of sophistication in beam generation and requires large equipment needs Another approach is to coat the prism with a thin film so that a probe beam experiences a rapid reflectivity change sensitive to changes of the external medium (such as a biological sample) at greater than critical angle. However, the metal coated on the prism must be specifically tailored such that the probe beam will induce plasmon resonances in the external medium so that the beam will experience absorption.

If, however, changes in the index of refraction could be measured without sophisticated manipulation of the laser beam, then less equipment could be used. Further, if changes in the index of refraction of a substance could be measured using a general procedure instead of using a specifically tailored metal film on the prism, then less expense and time could be used in measuring the changes in the index of refraction of the substance.

Therefore, there is a need in the art for measuring the index of refraction changes to a substance (e.g., gas) in a manner consistent with time-resolved studies on a femtosecond time scale without requiring sensitive engineering of the laser beam or without requiring the use of a specifically tailored metal coating on the prism.

### BRIEF SUMMARY OF THE INVENTION

In one embodiment of the present invention, a method for measuring an index of refraction comprises generating a probe beam directed at a total internal reflector. The method further comprises generating a diffraction pattern in a far-field based on a diffraction of an optical beam from a diffractor, where the optical beam is directed at the total internal reflector. The method further comprises measuring the index of refraction using one or more features of the diffraction pattern.

In another embodiment of the present invention, a method for calibrating the angle-axis of signals measuring changes in an index of refraction comprises generating a pump beam to propagate near a prism to induce index-changes in air by lining up air molecules outside of the prism. The method further comprises generating a probe beam directed at the prism. Additionally, the method comprises generating a sinc² pattern in a far-field based on a diffraction of a laser beam from a slit, where the laser beam is directed at the prism. In addition, the method comprises calibrating an angle-axis of the sinc² pattern using maxima of the sinc² pattern.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWING

A better understanding of the present invention can be obtained when the following detailed description is considered in conjunction with the following drawings, in which:

FIG. 1 illustrates a device configured to measure the index of refraction of a substance in accordance with an embodiment of the present invention;

FIGS. 2A-B are a flowchart of a method for calibrating the angle-axis of signals measuring the changes in the index of refraction of an ultra-fast phenomena on a femtosecond time scale in accordance with an embodiment of the present invention;

FIG. 3 is a graph illustrating how to determine the critical angle in accordance with an embodiment of the present invention; and

FIG. 4 represents real data used in measuring the index of refraction for air and carbon dioxide in accordance with an embodiment of the present invention.

### DETAILED DESCRIPTION

The present invention comprises a method for calibrating the angle-axis of signals measuring changes in an index of refraction. In one embodiment of the present invention, a pump beam is generated to propagate near a prism to induce index-changes in air by lining up air molecules outside of the prism. A generated probe beam is directed at the prism. A sinc² pattern is then generated in a far-field based on a diffraction of a laser beam from a slit, where the laser beam is directed at the prism. An angle-axis of the sinc² pattern is calibrated using the shape of the sinc² pattern. Additionally, a theoretical pattern is determined using the sinc² pattern, a reflectivity pattern, a width of the slit and a wavelength of the laser beam. A known substance can be used to calibrate the device. After replacing a known external substance to the prism with an unknown substance of a different index of refraction, the index of refraction of the unknown substance is measured using the theoretical pattern. In this manner, the index of refraction changes of a substance (e.g., gas) is measured in a manner consistent with time-resolved studies on a femtosecond time scale without requiring sensitive engineering of the laser beam or without requiring the use of a specifically tailored metal coating on the prism.

It is noted that, even though the following discusses measuring the index of refraction changes to gases, the principles of the present invention may be applied to many other fields, such as the semiconductor industry (e.g., monitor growth of thin films), and the biological industry (e.g., measure sugar levels in blood). It is further noted that a person of ordinary skill in the art would be capable of applying the principles of the present invention to such fields. It is further noted that embodiments covering such fields would fall within a scope of the present invention.

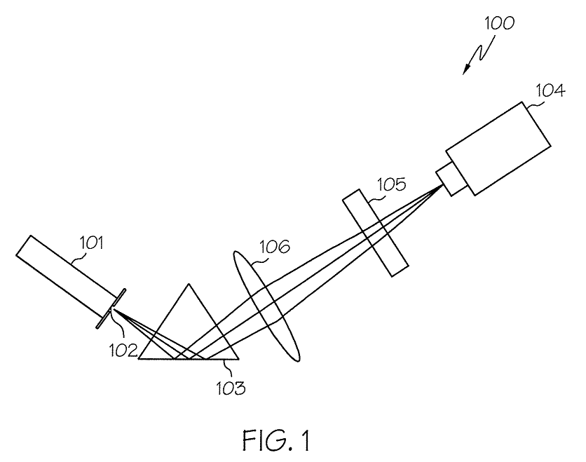

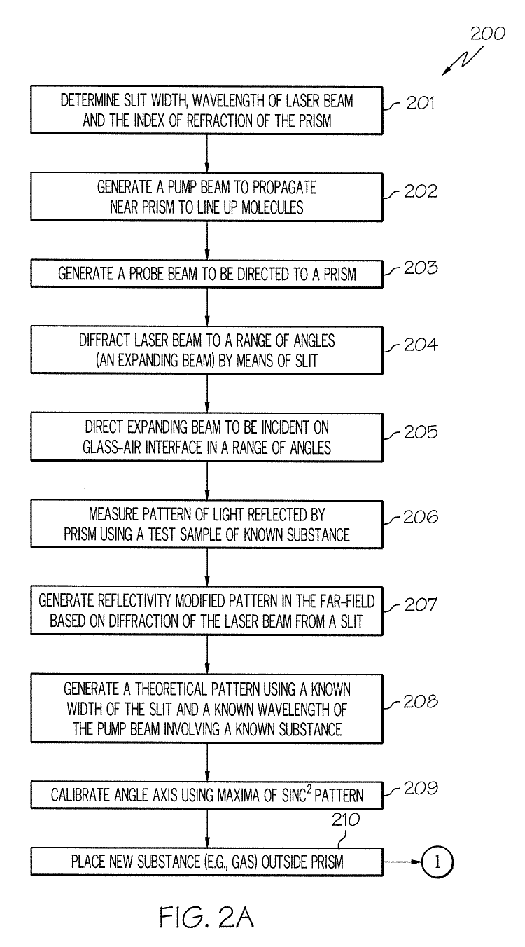

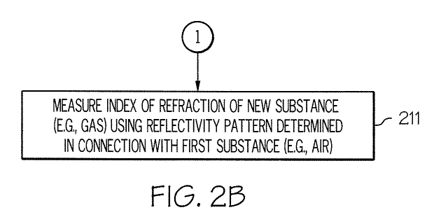

Referring to FIG. 1, FIG. 1 is an embodiment of the present invention of a device 100 configured to measure the index of refraction changes to a substance (e.g., solid, liquid, gas or plasma) due to a single, local interaction in the femtosecond time scale. Referring to FIG. 1, device 100 includes a light source 101 (e.g., laser) with the outputted light source (e.g., laser beam) being diffracted via a slit 102 as discussed below in connection with FIGS. 2A-B. The laser beam is directed at a prism 103. In one embodiment, light source 101 consists of broadband optical pulses. The light makes one interior reflection off the wall of prism 103 and exits prism 103. The light exiting prism 103 may be referred to herein as the “signal.” The signal may be detected by a camera 104 via a spherical lens 106, which projects the “far-field” to the CCD plane of camera 104. In this embodiment, a cylindrical lens 105 has been used to spread the beam across camera 104 to improve the signal to noise ratio. It is noted that cylindrical lens 105 may be unnecessary for cameras with greater dynamic range (e.g., greater than 8 bits).

Referring to FIG. 1, in one embodiment, the incoming pulses may be detected using a spectrometer or pulse diagnostics between cylindrical lens 105 and camera 104.

In one embodiment, device 100 uses a technique that assures that the detected signal originates from a known range of angles around the critical angle. The range of angles is known precisely through additional information that accompanies each measurement, and is thus an “auto-calibrating” technique. A more detailed explanation of the auto-calibration technique is explained below in connection with FIGS. 2A-B.

Referring to FIGS. 2A-B, FIGS. 2A-B are a flowchart of a method 200 for calibrating the angle-axis of signals measuring the changes in the index of refraction of an ultra-fast phenomena (e.g., gas) on a femtosecond time scale in accordance with an embodiment of the present invention. Referring to FIG. 2A, in connection with FIG. 1, in step 201, the width of slit 102, the wavelength of the laser beam and the index of refraction of prism 103 are determined. In step 202, a pump beam (intense, ultra-short laser beam) is generated to propagate near prism 103 to induce index-changes in the air by lining up the molecules (e.g., air molecules) outside prism 103. This alignment of the molecules changes the index of refraction. In step 203, an optical probe beam is generated to be directed at a total internal reflector, such as prism 103. The probe beam is used in this embodiment for the total internal reflection measurement for the changing air. In one embodiment, the probe beam is a continuous laser beam. In another embodiment, the probe beam is a chirped pulse such that a wavelength of the optical beam depends on time. In another embodiment, the probe beam is an optical pulse, such as an ultra-short, broadband pulse, where the optical pulse is measured to determine the index of refraction as discussed further below.

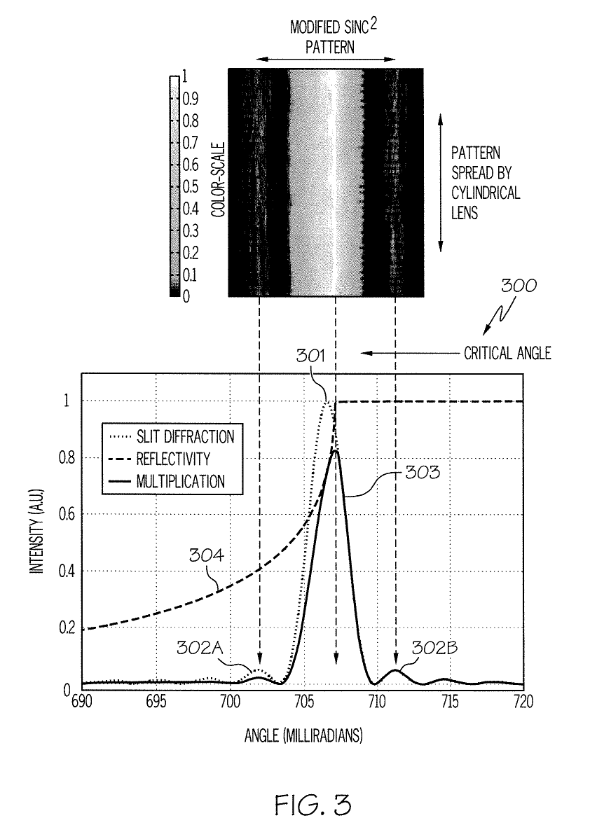

In step 204, the probe beam is diffracted to a range of angles (becoming an expanding beam) which is adjustable with the width of slit 102. In step 205, the expanding beam is directed to be incident on a glass-air interface in a range of angles including the critical angle for total internal reflection. In step 206, the pattern of light reflected by the total internal reflector, such as prism 103, is measured by camera 104 using a test sample of a known substance (e.g., air). An illustrative example of this measured pattern of light is provided in FIG. 3 as pattern 303 (identified as “multiplication” pattern in FIG. 3) which corresponds to the multiplication of sinc² pattern 301 and reflectivity pattern 304. The peak of pattern 303 determines the critical angle. Reflectivity pattern 304 corresponds to the reflectivity curve of the total internal reflection as calculated by Fresnal equations as known in the art.

After the pump-probe interaction, in step 207, a reflectivity modified pattern is generated in the far-field based on the diffraction of an optical beam, such as the laser beam, from a diffractor, such as slit 102, and subsequently altered by the reflectivity of prism 103. In step 208, a theoretical pattern is calculated by using known features of the diffractor, such as the slit width of slit 102, and a known wavelength of the optical or probe beam involving a known substance. For example, as illustrated in FIG. 3, using the known width of slit 102 and the known wavelength of the probe beam, sinc² pattern 301 (identified as “slit diffraction” pattern in FIG. 3) and reflectivity pattern 304 (identified as “reflectivity” pattern in FIG. 3) are used to calculate theoretical pattern 303 (identified as “multiplication” pattern in FIG. 3). FIG. 3 is a graph 300 of the angle (horizontal-axis) versus intensity (vertical-axis) illustrating how to determine the critical angle in accordance with an embodiment of the present invention as explained in further detail below. As illustrated in FIG. 3, sinc² pattern 301 includes maxima 302A, 302B, which are used to designate the limits of the x-axis (angle) of graph 300, and with a known critical angle (calibrated by measurement of a known substance), calibrate the entire angle axis, thereby allowing precise measurements of the small index changes in unknown materials. The entire curve 302B is then fit to data obtained with unknown substance parameters using just the index of refraction.

Referring to FIG. 2A, in step 209, the angle axis (x-axis) of graph 300 is calibrated using maxima 302A, 302B of sinc² pattern 301, as discussed above.

In step 210, a new substance (e.g., gas) is placed outside prism 102.

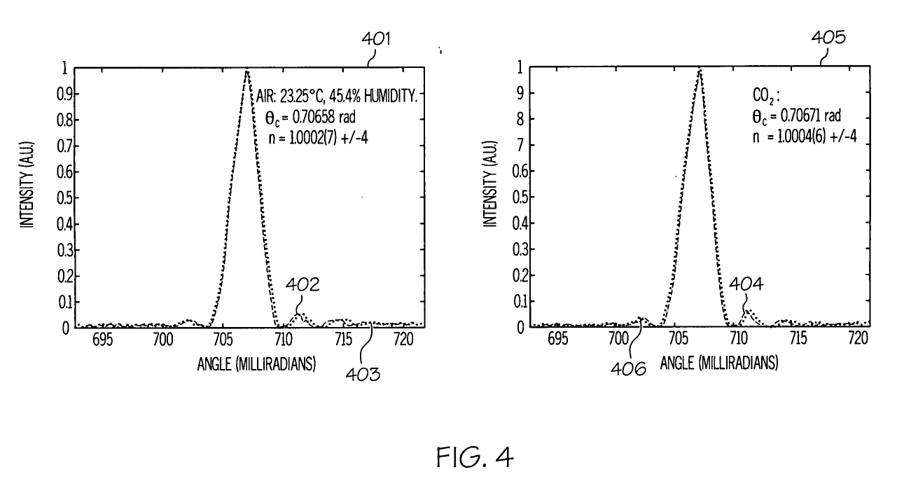

Referring to FIG. 2B, in conjunction with FIG. 1, in step 211, using reflectivity pattern 303 for the known substance, as a calibration reference, the index of refraction of the new substance (e.g., gas) is measured. Referring to FIG. 4, FIG. 4 represents real data used in measuring the index of refraction for air and carbon dioxide (CO₂). Referring to graph 401, pattern 402 (corresponding to pattern 303 of FIG. 3) is calculated for air (23.25° C. with 45.4% humidity) for the static index of refraction of air which defines the critical angle θ_{c} as 0.70658 radians. The index of refraction is known (the index of refraction (n) is 1.0002(7)+/−4), which tells us the critical angle and which is used to scale the x-axis. The device was used to generate an experimental curve 403 which is shown overlaid on curve 402. Carbon dioxide was then gently flowed over prism 103. Using pattern 406, the index of refraction of the new substance (e.g., gas) is measured as illustrated in graph 405. Pattern 404 is the fit of pattern 406 (corresponding to pattern 303 of FIG. 3) generated for the carbon dioxide. In the laboratory experiment, the critical angle θ_{c} for carbon dioxide was determined to be 0.70671 radians and the index of refraction (n) was determined to be 1.0004(6)+/−4, which is within experimental error of the accepted value.

Method 200 may include other and/or additional steps that, for clarity, are not depicted. Further, method 200 may be executed in a different order presented and that the order presented in the discussion of FIGS. 2A-B is illustrative. Additionally, certain steps in method 200 may be executed in a substantially simultaneous manner or may be omitted.

In an alternative method, the following additional steps may be used for a measurement using reflectivity in a time-dependent manner. The probe becomes a chirped pulse such that the wavelength depends on time. A spectrum of the signal is taken such that the spectral axis is orthogonal to the slit-diffraction direction. The chirp of the beam is determined such that the critical angle can be determined as a function of time. Calibration can also be done at each time-slice.

In another alternative method, the following additional steps may be used for a measurement of ultra fast processes (e.g., few femtoseconds) using phase as an additional signal. The probe is modified to comprise an ultra-short, broadband pulse. The electric-field amplitude and phase of the signal pulse is measured in a time-resolved manner using a standard technique, such as frequency-resolved optical gating. The portion of the pulse experiencing TIR is analyzed to determine from the rapidly-varying phase the rapidly-varying index of refraction.

In these processes, no light is needed to pass through the sample.

In one embodiment, by detecting both phase change and reflectivity (amplitude) change of the pulse, ultra-short measurements may occur using the above-described process. Measurements of ultra-short pulses are very sensitive to changes in the pulse phase. The phase change is detected through the use of the probe beam as is known in the art. As a result of using the amplitude and phase of the signal, index of refraction changes to ultra-fast phenomena (e.g., gas) may be detected on a femtosecond time scale.

It is noted that device 100 is compatible for use with ultra-short probe pulses when coupled additionally with a spectrometer or pulse-measuring device. Device 100 may even be used with white light, such as from an incandescent light bulb when used in reflectivity mode (not phase mode).

In one embodiment, device 100 can be used for continuous light probes to operate with the time resolution defined by a measurement device, such as a video camera.

Measurements of index changes remotely and in harsh atmospheres are possible, including extreme pressure and temperature conditions. Because total internal reflection is ubiquitous among transparent materials, the semiconductor industry could use the above-describe technique to monitor growth of thin films.

Further, the robust nature of device 100 could be used with other techniques without complicated laser alignment equipment. For example, sugar levels in blood affect the index of refraction of the blood plasma, which could be easily measured by device 100.

Additionally, device 100 may be used in an imaging configuration to obtain one dimensional information across a sample, which may be useful, for example, in real-time measurements of biological systems.

Device 100 may be embodied in many different environments. For example, device 100 may be embodied as an optical switch or as a remote sensor for airborne contaminates. Further, device 100 could be embodied as an alternative to thermocouples for measuring temperature changes in highly magnetic environments. Additionally, device 100 could be used in time-resolved measurements of nano-materials and their surfaces as an alternative to second-harmonic generation techniques. Further, device 100 could be used in time-resolved measurements of biological processes such as protein folding and neural activity.

Although the method is described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

1. A method for measuring an index of refraction, the method comprising:
generating a probe beam directed at a total internal reflector;
generating a diffraction pattern in a far-field based on a diffraction of an optical beam from a diffractor, wherein said optical beam is directed at said total internal reflector; and
measuring said index of refraction using one or more features of said diffraction pattern.

2. The method as recited in claim 1 further comprising:
calibrating an angle-axis of said diffraction pattern using said one or more features of said diffraction pattern.

3. The method as recited in claim 1 further comprising:
measuring a pattern of light reflected by said total internal reflector; and
measuring one or more features of said pattern measured.

4. The method as recited in claim 3, wherein said one or more features of said pattern measured determines a critical angle.

5. The method as recited in claim 1, wherein said probe beam is a continuous laser beam.

6. The method as recited in claim 1, wherein said probe beam is a chirped pulse such that a wavelength of said optical beam depends on time.

7. The method as recited in claim 1, wherein said probe beam is an optical pulse.

8. The method as recited in claim 7 further comprising:
measuring said optical pulse to determine said index of refraction.

9. The method as recited in claim 7, wherein said probe beam comprises an ultra-short, broadband pulse.

10. The method as recited in claim 1 further comprising:
determining a theoretical pattern using said diffractor, a reflectivity pattern and a wavelength of said optical beam.

11. A method for calibrating the angle-axis of signals measuring changes in an index of refraction, the method comprising:
generating a pump beam to propagate near a prism to induce index-changes in air by lining up air molecules outside of said prism;
generating a probe beam directed at said prism;
generating a sinc² pattern in a far-field based on a diffraction of a laser beam from a slit, wherein said laser beam is directed at said prism; and
calibrating an angle-axis of said sinc² pattern using one or more features of said sinc² pattern.

12. The method as recited in claim 11 further comprising:
measuring a pattern of light reflected by said prism; and
measuring a peak of said pattern measured.

13. The method as recited in claim 12, wherein said peak of said pattern measured determines a critical angle.

14. The method as recited in claim 11, wherein said probe beam is a chirped pulse such that a wavelength of said laser beam depends on time.

15. The method as recited in claim 11 further comprising:
determining a theoretical pattern using said sinc² pattern, a reflectivity pattern, a width of said slit and a wavelength of said laser beam

16. The method as recited in claim 15 further comprising:
replacing a known external substance to said prism with an unknown substance of a different index of refraction.

17. The method as recited in claim 16 further comprising:
measuring an index of refraction of said unknown substance using said theoretical pattern.

18. The method as recited in claim 11, wherein said probe beam comprises an ultra-short, broadband pulse.

19. The method as recited in claim 18 further comprising:
measuring an electric-field amplitude and a phase of a signal pulse using frequency-resolved optical gating.
